(19) United States
(12) Patent Application Publication
(10) Pub. No.: US 2025/0274179 A1
(43) Pub. Date: Aug. 28, 2025

(54) COMMUNICATION METHOD, USER EQUIPMENT AND BASE STATION

(71) Applicant: Samsung Electronics Co., Ltd., Suwon-si, Gyeonggi-do (KR)

(72) Inventors: Feifei SUN, Beijing (CN); He WANG, Beijing (CN); Bin YU, Beijing (CN)

(21) Appl. No.: 18/859,813

(22) PCT Filed: Apr. 27, 2023
(86) PCT No.: PCT/KR2023/005753

§ 371 Date: Oct. 24, 2024

(30) Foreign Application Priority Data
Apr. 27, 2022 (CN) 202210458183.6

(51) Int. Cl. H04B 7/06; H04L 41/16

(52) U.S. Cl. CPC H04B 7/0626; H04B 7/06952; H04L 41/16

(57) ABSTRACT

The disclosure relates to a 5G or 6G communication system for supporting a higher data transmission rate. The present disclosure provides a communication method, a user equipment, and a base station. The communication method comprises: acquiring CSI measurement configuration information; and, performing CSI measurement and reporting based on the CSI measurement configuration information. By acquiring CSI measurement configuration information and performing CSI measurement and reporting based on the CSI measurement configuration information, this scheme avoids the offset of CSI measurement caused by the time-varying characteristics of channels, and improves the spectrum efficiency and capacity of the wireless communication system.

### TECHNICAL FIELD

The present disclosure relates to the technical field of wireless communication, and in particular to a communication method, a user equipment, and a base station.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In NR systems, during channel status information (CSI) reporting, the CSI of a past time point or a certain past moment measured according to one or more pilot frequencies is usually reported. Due to the time-varying characteristics of channels, a certain offset will occur between the past CSI channel information received by the base station and the CSI channel information at the moment required for scheduling. In order to improve the spectrum efficiency and capacity of the system, the base station needs to obtain more accurate channel status information at the downlink scheduling moment. Therefore, it is necessary to provide a novel CSI measurement method.

### Solution to Problem

An objective of the present disclosure is to solve at least one of the above technical defects. The embodiments of the present disclosure employ the following technical schemes.

In a first aspect, an embodiment of the present disclosure provides a method executed by a user equipment (UE) in a wireless communication system, including:
acquiring CSI measurement configuration information; and
performing CSI measurement and reporting based on the CSI measurement configuration information.

In one optional embodiment of the present disclosure, the CSI measurement configuration information includes at least one of the following:
reference signal configuration information, a usage condition corresponding to one or more measurement modes, CSI measurement resource configuration information, measurement mode indication information, and report content.

In one optional embodiment of the present disclosure, the measurement mode includes a non-prediction mode or a prediction mode.

In one optional embodiment of the present disclosure, the measurement mode includes a non-AI mode or an AI mode.

In one optional embodiment of the present disclosure, the usage condition corresponding to the measurement mode includes at least one of the following:
a size relationship between a Doppler value and a threshold for Doppler;
a size relationship between a moving speed value and a threshold for moving speed;
a size relationship between a specified measurement result at a reference signaling position and a threshold for the specified measurement result; and
accuracies corresponding to different measurement modes.

In one optional embodiment of the present disclosure, the reference signal configuration information includes at least one of the following:
one or more reference signals;
time-domain position information of one or more reference signals; and
frequency-domain position information of one or more reference signals.

In one optional embodiment of the present disclosure, the reference signal satisfies at least one of the following conditions:
with the same Tx beam;
adopting the same precoding;
adopting the same transmission power;
adopting the same QCL; and
being indicated by the same TCI.

In one optional embodiment of the present disclosure, the measurement resource configuration information includes information about a time-domain and/or a frequencydomain position where CSI measurement is to be performed.

In one optional embodiment of the present disclosure, the resources indicated by the information about a time-domain and/or a frequency-domain position where CSI measurement is to be performed include the positions of all or some of the reference signals in the reference signal configuration information, or other reference signals not in the reference signal configuration information.

In one optional embodiment of the present disclosure, the information about a time-domain and/or a frequency-domain position where CSI measurement is to be performed includes at least one of the following:
one or more time-domain positions;
one or more frequency-domain positions;
one or more time intervals from the specified reference signaling position;
a frequency-domain offset from the specified reference signaling position;
the number of time-domain resources where CSI measurement is to be performed; and
the number of frequency-domain resources where CSI measurement is to be performed.

In one optional embodiment of the present disclosure, the performing CSI measurement based on the CSI measurement configuration information includes:
performing CSI measurement based on the one or more measurement modes and the usage conditions corresponding to the one or more measurement modes; and/or

In one optional embodiment of the present disclosure, the report content includes at least one of the following:
at least one CSI measurement result;

frequency-domain bandwidth information corresponding to at least one CSI measurement result;
information about time-domain and/or frequency-domain positions of at least one CSI measurement result;
Doppler information corresponding to at least one CSI measurement result; and
a measurement mode corresponding to at least one CSI measurement result.9

In one optional embodiment of the present disclosure, the method further includes:
reporting the UE capability to a base station, the UE capability comprising at least one of the following: supported CSI measurement mode(s), supported CSI content, input parameter(s) of the supported CSI measurement mode, and CSI calculation timeline.

In a second aspect, an embodiment of the present disclosure provides a method executed by a base station in a wireless communication system, including:
transmitting CSI measurement configuration information to a UE; and
receiving a CSI measurement result reported by the UE, wherein the CSI measurement result is measured by the UE based on the CSI measurement configuration information.

In a third aspect, an embodiment of the present disclosure provides a user equipment, including:
a transceiver; and
a processor, which is coupled to the transceiver and configured to control to execute the steps of the method executed by a UE provided in the present application.

In a fourth aspect, an embodiment of the present disclosure provides a base station, including:
a transceiver; and
a processor, which is coupled to the transceiver and configured to control to execute the steps of the method executed by a base station provided in the present application.

In a fifth aspect, an embodiment of the present disclosure provides an electronic device, including a memory and a processor;
the memory has computer programs stored thereon; and
the processor is configured to execute the computer programs to implement the methods provided in the embodiment of the first aspect or any optional embodiment of the first aspect and the embodiment of the second aspect or any optional embodiment of the second aspect.

In a sixth aspect, an embodiment of the present disclosure provides a computer-readable storage medium having computer programs stored thereon that, when executed by a processor, implement the methods provided in the embodiment of the first aspect or any optional embodiment of the first aspect and the embodiment of the second aspect or any optional embodiment of the second aspect.

### Advantageous Effects of Invention

The technical solutions provided by the present disclosure has the following beneficial effects.

By acquiring CSI measurement configuration information and performing CSI measurement and reporting based on the CSI measurement configuration information, these solutions avoid the offset of CSI measurement caused by the time-varying characteristics of channels, and improve the spectrum efficiency and capacity of the wireless communication system.

### BRIEF DESCRIPTION OF DRAWINGS

The above and/or additional aspects and advantageous of the present invention will become apparent and be readily appreciated from the following descriptions of embodiments with reference to the accompanying drawings, in which:

FIG. 1 is an example wireless network according to various embodiments of the present disclosure;

FIGS. 2a and 2b are example wireless transmitting and receiving paths according to an embodiment of the present disclosure;

FIG. 3a is an example UE according to an embodiment of the present disclosure;

FIG. 3b is an example gNB according to an embodiment of the present disclosure;

FIG. 4 is a flowchart of a method executed by a UE in a communication system according to an embodiment of the present disclosure;

FIG. 5 is a schematic diagram of the slot positions where CSI measurement is to be performed in an example according to an embodiment of the present disclosure;

FIG. 6 is a schematic diagram indicating the positions of reference signals and the time-domain and/or frequency-domain positions where CSI measurement is to be performed in an example according to an embodiment of the present disclosure;

FIG. 7 is a schematic diagram of the input/output of a prediction mode based on an AI model according to an embodiment of the present disclosure;

FIG. 8 is a schematic diagram of performing CSI measurement in a certain slot in a prediction mode based on an AI model in an example according to an embodiment of the present disclosure;

FIG. 9 is a schematic diagram of performing CSI measurement in a certain resource block in a prediction mode based on an AI model in an example according to an embodiment of the present disclosure;

FIG. 10 is a schematic diagram of information interaction of CSI measurement in an example according to an embodiment of the present disclosure;

FIG. 11 is a schematic diagram of CSI report contents in an example according to an embodiment of the present disclosure;

FIG. 12 is a flowchart of a method executed by a base station in a communication

system according to an embodiment of the present disclosure; and

FIG. 13 is a schematic structure diagram of an electronic device according to an embodiment

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In NR systems, during channel status information (CSI) reporting, the CSI of a past time point or a certain past moment measured according to one or more pilot frequencies is usually reported. Due to the time-varying characteristics of channels, a certain offset will occur between the past CSI channel information received by the base station and the CSI channel information at the moment required for scheduling. In order to improve the spectrum efficiency and capacity of the system, the base station needs to obtain more accurate channel status information at the downlink scheduling moment. Therefore, it is necessary to provide a novel CSI measurement method.

In recent years, artificial intelligence (AI) technologies represented by deep learning algorithms have risen again to solve the problems existing in all walks of life for many years, and have achieved great success in technology and business. With the continuous evolution of wireless communication systems, these problems on air interfaces have been studied and tried to be solved by introducing new methods. In recent years, solutions based on AI technology have been widely studied for many problems related to the air interfaces of wireless communications, and some results theoretically better than those of the conventional algorithms have been produced. In the standardization discussion of the upcoming Rel-18 version of 5G NR by standard organization 3GPP, the AI-based physical layer wireless communication technology is also widely discussed and will be possibly written in the standards of 5G and/or 6G wireless communication technology in the future.

In order to solve some problems in the communication process, machine learning methods can be used. The machine learning methods generally include the algorithm design of machine learning and the machine learning model design on which the algorithm is based. For the machine learning algorithm, there are usually two different stages, i.e., a training state and a reasoning stage. Generally, the machine learning model can first experience the training stage, that is, the parameter weights in the machine learning model are learned according to the task objective. In this case, the data provided for training may be obtained online or offline. At the end of the training, the machine learning model can be used in the reasoning state, that is, the tasks such as optimization, prediction, classification, and regression are carried out according to the result of model training. The two stages may be carried out separately and sequentially or may be carried out alternately.

The solutions based on the AI deep learning (DL) technology generally refer to algorithms using the artificial neural network as a model in the machine learning technology. The deep learning network model is usually composed of multiple layers of stacked artificial neural networks. The weight parameters in the neural networks are adjusted by training the existing data, and then used in the reasoning stage to achieve task objectives in unexpected situations. Meanwhile, generally, compared with the general solutions or algorithms based on fixed rules, the DL-based solutions require higher operational capability than the original classical algorithms, so that a dedicated operation chip is usually needed in the device running the DL algorithm to support more efficient operation of the DL algorithm.

Using the AI algorithms based on machine learning to solve the problems in communication generally needs to satisfy the conditions of machine learning problems. Among the problems in communication and the problems related to air interfaces, many problems such as channel information feedback, reference signal estimation, beamforming and UE positioning satisfy the conditions to a certain extent and thus can be solved by machine learning algorithms, thereby achieving better effects than the conventional solutions during the communication transmission process.

Herein, the term “machine learning algorithm and model” may be interchangeably used with the “AI/ML-based technology”, “AI/ML for NR air interfaces”, “AI/ML architecture”, “AI/ML model”, “AI/ML for air interfaces”, “AI/ML method” and “AI/ML related algorithm”, “AI/ML-based algorithm” and “AI/ML scheme”.

The embodiments of the present disclosure provide a method for predicting CSI or beams. For convenience of description, the embodiments of the present disclosure will be described by taking CSI as an example.

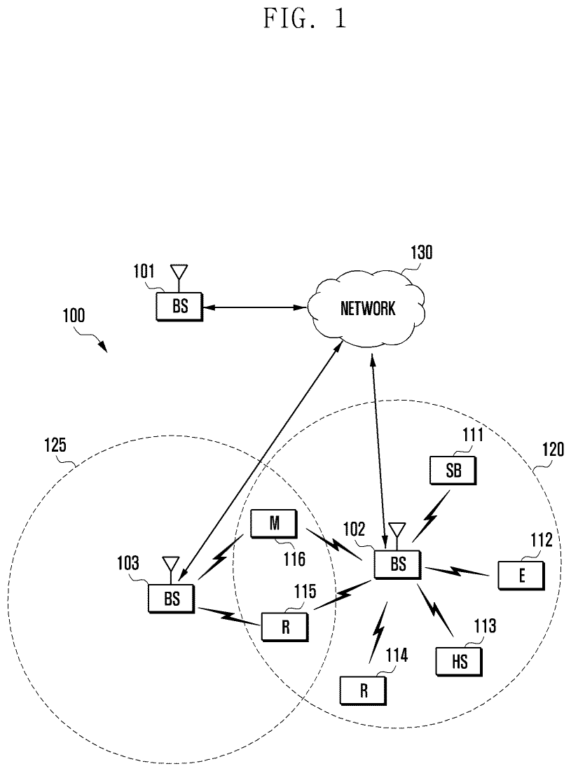

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).
gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

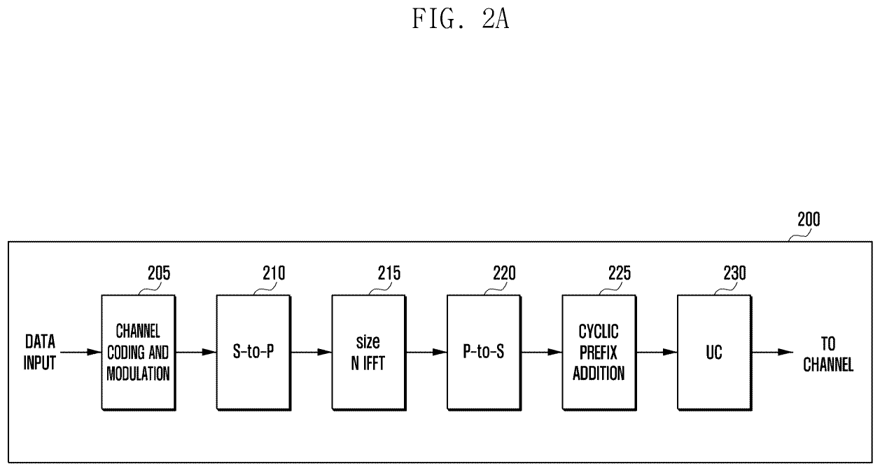

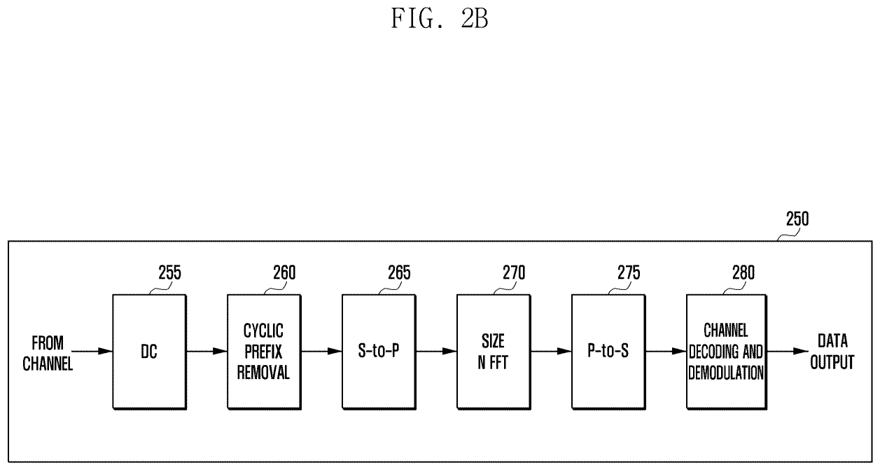

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

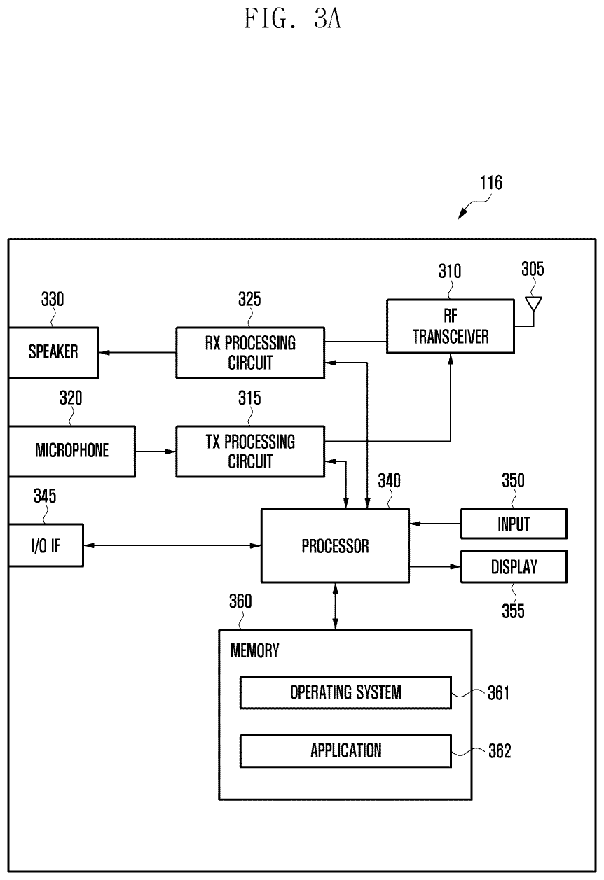

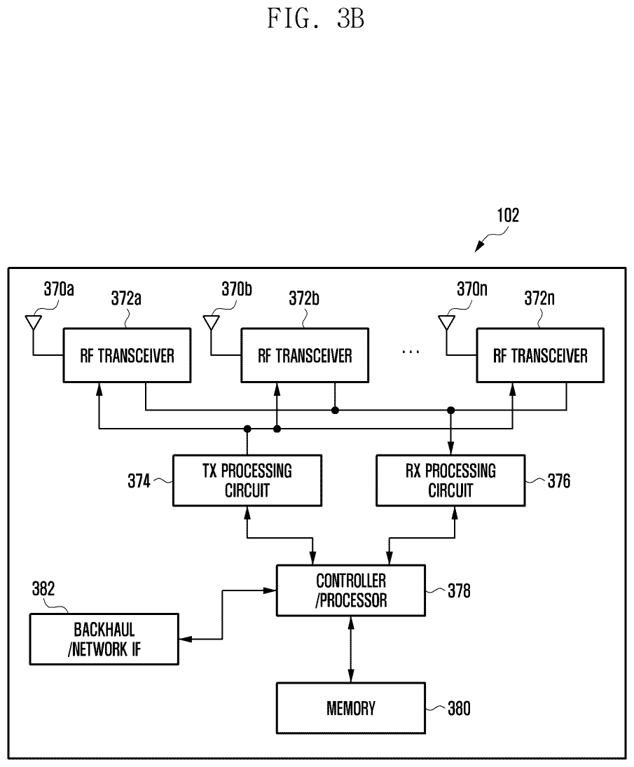

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

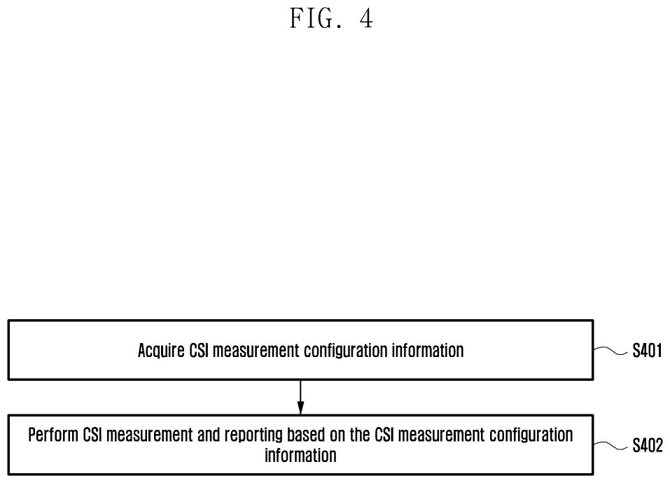

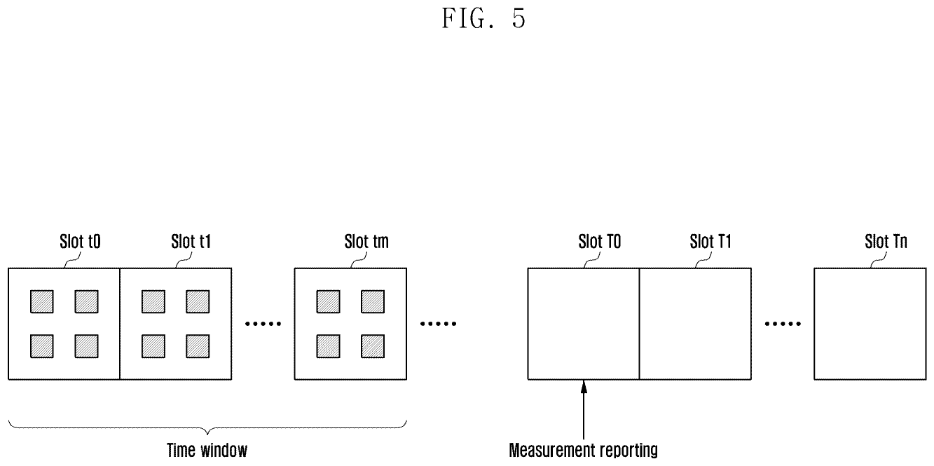

FIG. 4 is a flowchart of a method executed by a UE in a communication system according to an embodiment of the present disclosure. As shown in FIG. 4, the method may include the following actions. At S401, CSI measurement configuration information is acquired. At S402, CSI measurement and reporting are performed based on the CSI measurement configuration information.

Specifically, the UE acquires the corresponding CSI measurement configuration information before performing CSI measurement and reporting, and the CSI measurement configuration information is issued by a base station. Then, the UE performs CSI measurement based on the acquired CSI measurement configuration information, and reports the CSI measurement result obtained by measurement to the base station based on the CSI measurement configuration information.

In accordance with the scheme provided by the embodiment of the present disclosure, by acquiring CSI measurement configuration information and performing CSI measurement and reporting based on the CSI measurement configuration information, this solution avoids the error of CSI measurement caused by the time-varying characteristics of channels, and improves the spectrum efficiency and capacity of the wireless communication system.

In one optional embodiment of the present disclosure, the CSI measurement configuration information may include:

reference signal configuration information, usage conditions corresponding to one or more measurement modes, CSI measurement resource configuration information, measurement mode indication information, and report content.

For the reference signal (RS) configuration information, the CSI-RS may be used as a reference signal for CSI measurement. The base station may configure the CSI-RS for the UE through an RRC, or use an MAC layer or DCI to configure or modify the CSI-RS configuration through the RRC more quickly. Specifically, for example, the CSI-RS is classified into periodic and aperiodic CSI-RS. The periodic CSI-RS is configured through the RRC, while the aperiodic CSI-RS is configured through the RRC and then configured or triggered by the DCI or MAC. The configuration includes the time-frequency resource position of the CSI-RS, the frequency-domain resource position of the CSI-RS, the periodicity, the sequence of the CSI-RS, the port information of the CSI-RS, the beam information of the CSI-RS (e.g., quasi co-location (QCL), transmission configuration indication (TCI) information, etc.), etc.

In short, the reference signal configuration information includes at least one of the following: one or more reference signals; time-domain position information of one or more reference signals; and, frequency-domain position information of one or more reference signals. The reference signal satisfies at least one of the following conditions: having the same precoding; adopting the same transmission power; adopting the same QCL; and, being indicated by the same TCI. In one example, the reference signals are all of QCL type D: having the same spatial Rx parameter. That is, the reference signals are from the same beam. It means that the UE can performs reception by using the same Rx beam.

The CSI measurement resource configuration includes information about time-domain and/or frequency-domain positions where CSI measurement is to be performed. The resources indicated by the information about time-domain and/or frequency-domain positions where CSI measurement is to be performed include the positions of all or some of reference signals in the reference signal configuration information, or other reference signals not in the reference signal configuration information. The reference signals represent reference signals used for actual CSI measurement. The UE may obtain the CSI of the positions of the reference signals according to the reference signals, and further obtain the CSI of the time-frequency resource positions where CSI measurement is to be performed. The information about time-domain and/or frequency-domain positions where CSI measurement is to be performed includes at least one of the following: one or more time-domain positions; one or more frequency-domain positions; one or more time intervals from the specified reference signaling position; a frequency-domain offset from the specified reference signaling position; and, the number of time-domain resources where CSI measurement is to be performed.

Compared with the prior art in which only the CSI of the resources with reference signaling positions is fed back, the technical scheme provided in this embodiment of the present disclosure can predict the channel status information on time-domain resources without real reference signaling positions. Since the time-frequency resource positions where CSI measurement is to be performed may be future resource positions, the base station may perform resource scheduling the prediction result. Accordingly, compared with being based on the past time-frequency resource positions, more accurate channel status information can be obtained, and the throughput of the system can thus be improved. In addition, the scheme provided in this embodiment of the present disclosure can also predict the CSI of the frequency-domain resource positions (which may be past or future resource positions) without real pilots. This application scheme can reduce the pilot overhead, reduce the receiving complexity of the UE, and save the energy consumption of the UE (avoid the use of large bandwidth for downlink signal reception).

In an LTE or NR system, the base station will configure how the UE reports the CSI measurement result. Generally, the base station will explicitly configure the time-frequency resource position of the CSI measurement result, i.e., the information about the time-domain and/or frequency-domain position where the CSI measurement is to be performed. The time-domain resource position will usually occur before reporting. As shown in FIG. 5, the base station will instruct the UE to report the CSI measurement result of the slot tm, and the uplink PUCSCH or PUCCH that bears the CSI report information will occur after the slot tm, e.g., slot TO. The base station receives, at slot T0, the CSI measurement result of the slot tm, and then performs subsequent scheduling (e.g., in a slot Tn) according to the result. As described above, since the channel is time-varying, it is inaccurate to schedule the slot Tn by using only the CSI measurement result of the slot tm. Therefore, in the embodiment of the present disclosure, the UE can predict the channel status information of future slots, or the UE can predict the channel status information of frequency-domain positions without real reference signals, and then report the channel status information to the base station for providing a reference for better scheduling. The future slots or the frequency-domain resources except for the resources where reference signals are located do not contain the reference signals for measurement.

Similarly, the UE may measure reference signals on some time-frequency resources, and then predict the CSI of time-frequency resources without reference signals according to the features of the channel, etc. This prediction may be called frequency-domain prediction.

For the measurement mode, the base station may configure, for the UE, the measurement mode of CSI measurement by using the CSI measurement configuration information. Specifically, according to different CSI measurement configuration information, the UE determines that the measurement mode is also different. Generally, the measurement mode may include the following two modes.
(1) The base station may issue one or more measurement modes and their corresponding usage conditions. The UE determines to use which measurement mode(s) according to the usage conditions corresponding to each measurement mode, i.e., determining one or more target measurement modes, and then performs CSI measurement according to the one or more target measurement modes.

In other words, the performing CSI measurement based on the CSI measurement configuration information includes:
determining a target measurement mode based on the measurement mode and the usage conditions corresponding to the measurement mode; and
obtaining the corresponding CSI measurement result based on the target measurement mode and the reference signal configuration information.
(2) The base station may also directly specify that the UE adopts one or more specified measurement modes for CSI measurement. The UE adopts, according to the indication from the base station, the one or more specified measurement modes for CSI measurement.

In other words, the CSI measurement configuration information further includes measurement mode indication information; and, the performing CSI measurement based on the CSI measurement configuration information includes:
determining one or more specified measurement modes based on the measurement mode indication information; and
performing CSI measurement based on the one or more specified measurement modes and the reference signal configuration information.

Specifically, the base station may configure multiple measurement modes for the UE through an RRC. For example, the base station may configure multiple AI models and/or non-AI measurement methods for the UE. Further, the base station may indicate, by using MAC or DCI information and to the UE, one or more specified measurement modes among the multiple measurement modes configured through the RRC to perform CSI measurement.

In one optional embodiment of the present disclosure, the measurement mode includes a non-prediction mode or a prediction mode. Further, the non-prediction mode includes a non-prediction mode not based on an AI model or a non-prediction mode based on an AI model; and, the prediction mode includes a prediction mode not based on an AI model or a prediction mode based on an AI model.

Specifically, the UE performing CSI measurement according to different measurement modes may include at least one of the following:
performing CSI measurement according to the RS information configured in the CSI measurement configuration information; and
performing CSI measurement according to the RS information configured in the CSI measurement configuration information, and predicting CSI of a specific time-domain and/or frequency-domain position. The predicting CSI of a specific time-domain and/or frequency-domain position includes a prediction mode not based on an AI model and a prediction mode based on an AI model.

In one optional embodiment of the present disclosure, the usage conditions corresponding to the measurement mode include at least one of the following:
a size relationship between a Doppler value of the current channel and a threshold for Doppler;
a size relationship between a moving speed value of the current channel and a threshold for the moving speed;
a size relationship between a specified measurement result of the current channel at a reference signaling position and a threshold for the specified measurement result; and
the accuracy corresponding to a different measurement mode adopted by the current channel.

The specified measurement result includes a reference signal received power (RSRP) or a signal to interference plus noise ratio (SINR).

The AI model is trained for specific conditions, so the channel prediction performance based on the AI model may be different according to different conditions. For example, for different SINRs (or SNRs), the channel prediction performance of the AI model will be different. Even for a specific SINR, the channel prediction performance of the AI model may be lower than that of the conventional algorithms, for example, interpolation based methods or other conventional methods. Similarly, under different conditions, it may be necessary to match different AI models, or the accuracy of the prediction result of the specific AI model is different. For example, under different moving speeds in vehicle speed test, different Doppler, different frequency points, different bandwidths, or other conditions, different AI models may be required to achieve better performance. Therefore, the UE or the base station may determine a method for channel prediction according to some conditions or configurations. For example, a suitable AI model is selected to perform CSI measurement (e.g., performing CSI prediction on a specific time-frequency resource block). Or, the UE or the base station may determine whether to perform channel prediction according to some conditions or configurations. The moving speed in vehicle speed test is also called vehicle speed, and in the present disclosure, when referring to a vehicle speed or a moving speed, it may correspond to a moving speed of a UE or a moving speed of the channel.

Specifically, the determining a target measurement mode based on the measurement mode and the usage conditions corresponding to the measurement mode includes the following.
(1) The target measurement mode is determined based on the size relationship between the Doppler value of the current channel and the threshold for Doppler or the size relationship between the moving speed value of the current channel and the threshold for the moving speed.

The UE may determine, according to the configuration of the base station or its own understanding of the AI model performance, the size relationship between the Doppler value of the current channel and the threshold for Doppler value, or determine a method for CSI measurement and/or prediction based on the moving speed value of the current channel and the threshold for the moving speed. For example, if the Doppler value or moving speed value of the current channel is greater than and/or equal to and/or less than the corresponding threshold for Doppler or threshold for moving speed, the non-prediction mode is adopted. For example, if the Doppler value or moving speed value of the current channel is greater than and/or equal to and/or less than the corresponding threshold for Doppler or threshold for moving speed, the prediction mode based on an AI model is adopted (including selecting a suitable AI model). Specifically, according to the configuration of the base station or the past experience of the UE, it is determined that the AI model 1 is suitable for channel prediction in a situation where the moving speed or Doppler value is greater than a certain threshold, and the AI model 1 is suitable for channel prediction in a situation where the moving speed or Doppler value is less than the threshold. Thus, the UE can select a suitable AI model for channel prediction according to the current moving speed or Doppler value. Or, if the Doppler value or the moving speed value of the current channel is greater than and/or equal to and/or less than the corresponding threshold for Doppler or threshold for moving speed, the prediction mode not based on the AI model among the prediction modes is adopted. For example, the channel status information is interpolated by only using the conventional method. The threshold for Doppler or the threshold for moving speed may be obtained through the configuration of the base station.

Similarly, in the above method, the threshold for Doppler or the threshold for moving speed may be replaced with the threshold for the specified measurement result, e.g., RSRP, SINR, etc. The UE may determine, according to the size relationship between the specified measurement result of the current channel at a reference signaling position and the threshold for the specified measurement result, to adopt at least one of the following measurement modes: a non-prediction mode, a prediction mode not based on an AI model, and a prediction mode based on an AI model. Further, the prediction mode based on an AI model may also be determined as a prediction mode based on one or more of multiple AI models.

In this way, the performance of channel information prediction can be improved, or the error caused by channel prediction can be reduced or avoided.
(2) The target measurement model is determined based on the accuracy of a different measurement mode adopted by the current channel.

The node (e.g., the UE or base station) that executes the prediction mode based on an AI model can estimate the accuracy of the prediction mode based on an AI model, for example, a normalized mean square error (NMSE) value, a cosine similarity (CS), etc. Or, the accuracy of the prediction mode based on an AI model is determined based on the size relationship between the result of the cost function trained by the AI model and the expectation (e.g., the predefined result). In other words, it is determined whether the AI model is suitable for the current scenario. Specifically, the node (e.g., the UE or base station) that executes the prediction mode based on an AI model can determine whether to perform prediction according to the expected measurement and/or prediction result, and select an AI model with the best performance for prediction. If the UE autonomously determines whether to predict the reported information as well as the predicted time interval or the predicted time-domain/frequency-domain resource position, the UE may carry auxiliary information in the information reported to the base station. The auxiliary information includes at least one of the following: whether to predict, the predicted time interval, the predicted frequency-domain interval, and the predicted time-domain and/or frequency-domain resource position.

The base station may determine the time-domain and/or frequency-domain position information corresponding to the reported measurement result according to the measurement result reported by the UE and the auxiliary information, thereby realizing more accurate scheduling and improving the system performance.

In one optional embodiment of the present disclosure, obtaining the corresponding CSI measurement result based on the target measurement mode and the reference signal configuration information includes:
acquiring input parameter(s) of the measurement mode based on the reference signal configuration information; and
acquiring a CSI measurement result based on the input parameter and the measurement mode.

Further, the acquiring a CSI measurement result based on the input parameter and the measurement mode includes:
inputting the input parameter into an AI model corresponding to the measurement mode, and outputting a CSI measurement result of a time-domain and/or frequency-domain position where CSI measurement is to be performed.

The input parameter includes at least one of the following: at least one reference signal (RS); the CSI measurement result of the position of at least one reference signal; the received signal at the position of at least one reference signal; and, information about the time-domain and/or frequency-domain position where CSI measurement is to be performed. Each reference signal satisfies at least one of the following conditions: having the same transmitting beam (Tx beam); adopting the same precoding; adopting the same transmission power; adopting the same QCL; and, being indicated by the same TCI. At least one piece of RS information includes at least one of the following: one or more reference signals; the time-domain position information of one or more reference signals; and, the frequency-domain position information of one or more reference signals. One reference signal may refer to a reference signal on one resource element (RE), or a pilot sequence of multiple REs occupied by the pilot on one system. The information about time-domain and/or frequency-domain positions where CSI measurement is to be performed includes at least one of the following: one or more time-domain positions; one or more frequency-domain positions; one or more time intervals from the specified reference signaling position; a frequency-domain offset from the specified reference signaling position; and, the number of time-domain resources where CSI measurement is to be performed.

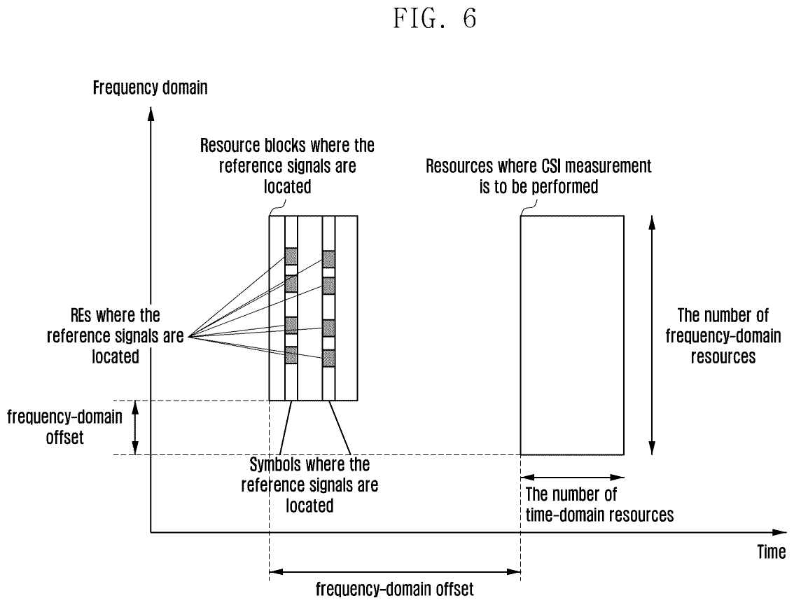

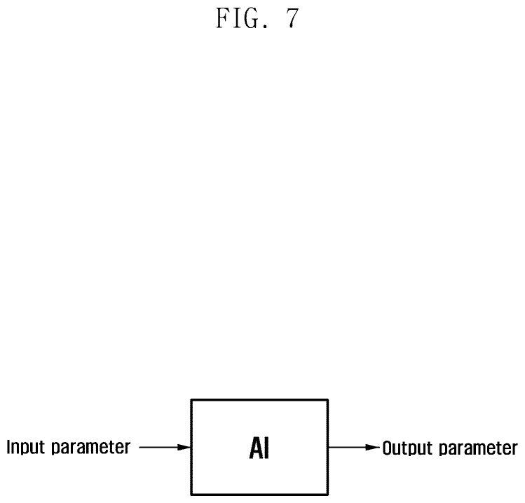

FIG. 6 shows a schematic diagram indicating the positions of reference signals and the time-domain and/or frequency-domain positions where CSI measurement is to be performed in an example according to an embodiment of the present disclosure. The reference signals occupy some REs in one resource block, and the resource block occupied by the reference signals is composed of a plurality of symbols in one or more physical resource block (PRB). The reference signal on the symbol where one reference signal is located bears one pilot sequence. The pilot sequence may be calculated according to the predefined rule and the parameters configured by the base station. For a resource where CSI measurement is to be performed, the base station may directly indicate the frequency-domain information (e.g., the serial numbers of PRBs, the number of PRBs, etc.) and/or time-domain information (e.g., slot position, symbol position, the number of slots and/or symbols, etc.). Or, it may be obtained by indicating the offset from the reference signal position and the number of resources. Specifically, the time-domain start position of the resource where CSI measurement is to be performed may be obtained by using the time-domain offset between the position of the first symbol of the resource block where the reference signal is located and the position of the first symbol of the resource where CSI measurement is to be performed (e.g., the offset in symbol and/or slot, or the offset in absolute time). The time-domain position is determined according to the number of time-domain resources (e.g., time units such as symbols or slots) of the resource where CSI measurement is to be performed. Similarly, the frequency-domain start position of the resource where CSI measurement is to be performed may be obtained by using the frequency-domain offset between the position of the first PRB or sub-carrier of the resource block where the reference signal is located and the position of the first PRB or sub-carrier of the resource where CSI measurement is to be performed (e.g., the offset in sub-carrier and/or PRB, or the offset in absolute frequency domain). The time-domain position is determined according to the number of frequency-domain resources (e.g., time units such as PRBs or sub-carriers) of the resource where CSI measurement is to be performed.

The UE obtains the channel information of the reference signaling position by receiving the signal on the resource block, the symbol or the RE where the reference signal is located and then performing signal processing (e.g., extracting the received signal on the RE where the reference signal is located, and performing a point division operation (least mean square channel estimation) on the pilot, or performing AI processing, etc.). The channel status information on the resource position where CSI measurement is to be performed is further obtained by signal processing (e.g., AI or non-AI methods). Or, the signal status information of the resource at the position where CSI measurement is to be performed may be directly obtained by signal signaling (AI-based or non-AI-based methods) according to the received signal at the reference signaling position and the reference signal.

The CSI measurement result of the position where at least one reference signal is located includes at least one of the following: the channel estimation result at the position where one or more reference signals are located; the frequency-domain channel response or time-domain channel response at the position where one or more reference signals are located; the frequency-domain or time-domain channel impulse response at the position where one or more reference signals are located; and, the frequency-domain or time-domain channel impulse response of the time-domain resource block where one or more reference signals are located.

The reference signal configuration information may include reference signaling position information at multiple moments where channel interpolation and/or extrapolation can be performed. For example, for multiple symbols or slots within one window, the CSI-RS of the same antenna ports may be considered as having the same characteristics. Specifically, the specific pilots (e.g., with the same antenna port number) within this window have the same Tx beam, adopt the same precoding, adopt the same transmission power, adopt the same QCL, are indicated by the same TCI, etc.

Specifically, when the prediction mode is used as the measurement mode, it is necessary to determine the input parameter and output parameter of the prediction model. As shown in FIG. 5, the embodiment of the present disclosure will be described by taking the prediction mode based on an AI model as an example. The UE can use the measurement result at the position where the reference signals having the same characteristics are located, or the RS information and the received signal information, as the input of the AI model, so as to predict the channel information of a future moment or slot.

At this time, the output parameter of the AI model may be the channel status information of the time-domain and/or frequency-domain position of the resource where CSI measurement is to be performed. The channel status information may be CSI information, a precoding matrix indicator (PMI), a rank indicator (RI), etc. Or, the status information may be full channel information such as the time-domain or frequency-domain impulse response of the channel, or other forms representing the channel status information.

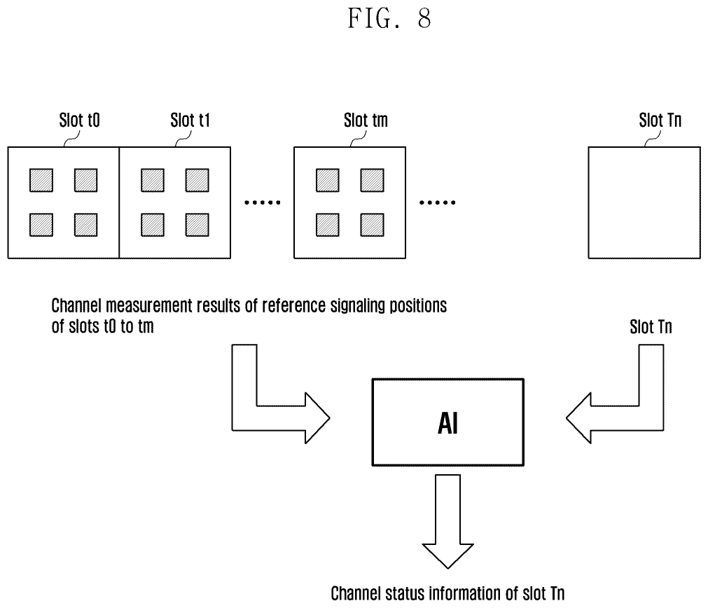

As shown in FIG. 8, in one example, an example of predicting the channel status information of a future slot Tn based on the measurement result at least one historical reference signaling position is given. The channel measurement results at the reference signaling positions in slots t0-tm and the moments of the time position slot Tn output by prediction are input into the AI model as input parameters to obtain the channel status information of the slot Tn predicted by the AI model. The slots t0-tm may be obtained according to the time window preconfigured by the base station, or may be autonomously determined by the UE. The output slot Tn may be a prediction time interval configured by the base station. In another example, the output of the AI model may be the channel status information prediction results of multiple slots Tn0-Tnk. In a specific implementation, multiple channel status information results can be obtained by training one AI model, and different AI models can be trained for different output slot positions, so that the output accuracy is improved. In addition, the input slot Tn may be replaced with other time units, e.g., symbol, millisecond, etc. In another example, the input parameter slot Tn of the AI model may be a time interval from a certain reference signaling position among one or more input reference signaling positions, for example, an interval Tn-tm from the slot where the last pilot is located, or an interval Tn-t0 from the slot where the first pilot is located, etc. The slot may be replaced with a time unit, e.g., one or more symbols.

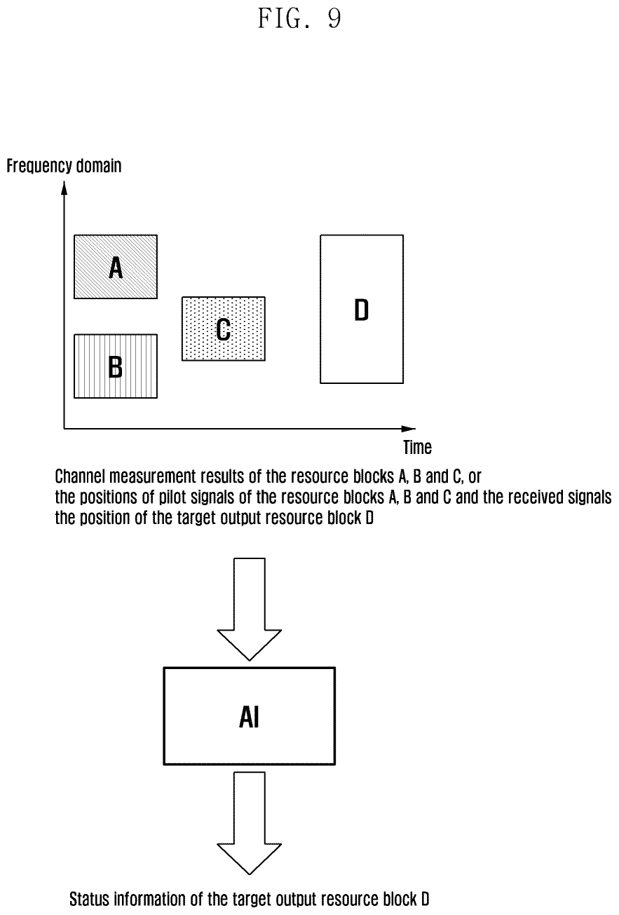

As shown in FIG. 9, in one example, an example of predicting the channel status information on a resource block D based on the measurement result on at least one received time-domain resource (or the received signal at the reference signaling position) (e.g., the measurement result on the resource blocks A, B and C for measurement) is given. The reference signals for measurement are located on the resource blocks A, B and C, while there are no reference signals for measurement on the predicted resource block D. The UE inputs the measurement results on the resource blocks A, B and C for measurement or the received signals at the reference signaling positions into the AI model as input parameters. Further, the information of the target resource block D may also be input into the AI model as input parameter(s). Prediction is performed according to the AI model to obtain the channel status information on the target resource block D. The resource blocks A, B and C for measurement may be obtained according to the pre-configuration of the base station, or may be autonomously determined by the UE. The target resource block B may be configured by the base station. In another example, the target resource block D may be multiple resource blocks. The target resource block D may past, current, or future resource blocks. The target resource block D may have a frequency-domain position that is identical to, different from or partially identical to those of the input measurement resource blocks A, B and C (e.g., having all or some PRBs, BWPs, sub-bands, etc.). That is, the target resource block D may include reference signals for measurement, or may not include reference signals for measurement, or may include some reference signals for measurement. In a situation where the target resource block D is not overlapped with the resource blocks A, B and C in frequency domain, the prediction in frequency domain may be performed by an AI-based method or a non-AI method, e.g., interpolation or extrapolation.

Similarly, the output of the AI model may be the channel status information prediction results of multiple target resource blocks. In a specific implementation, the channel status information results of multiple target resource blocks can be obtained by training one AI model, and different AI models can be trained for the positions of output target resource blocks, so that the output accuracy is improved. Specifically, the input of the AI model may be the absolute positions of the target resource blocks and/or the resource blocks for measurement (e.g., the serial numbers of PRBs or the serial numbers of slots), or the relative position relationship between the target resource blocks and the measurement resource blocks (e.g., frequency-domain offset and/or time-domain offset, etc.), etc.

The above methods for the input and output of the AI model are also applicable to non-AI prediction methods.

In one optional embodiment of the present disclosure, the method may further include:
reporting the supported measurement mode to the base station, the UE capability including at least one of the following: the supported CSI measurement mode, the supported CSI content, input parameter(s) of the support CSI measurement mode, and the calculation capability for CSI measurement.

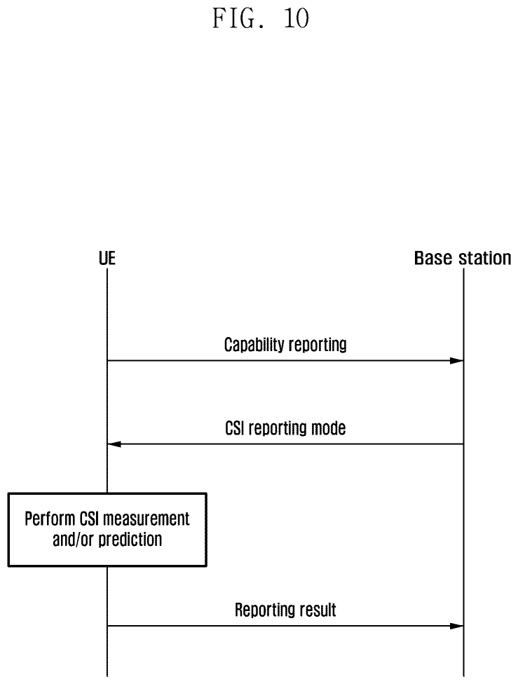

Specifically, as shown in FIG. 10, the CSI measurement method provided in the embodiment of the present disclosure may include the following actions.
(1) The UE reports the UE capability to the base station. The UE capability includes: the capability for CSI measurement and/or prediction (i.e., the measurement mode supported by the UE), or the CSI content supported by the UE, the input parameter of the supported CSI measurement mode, and the CSI calculation timeline. Specifically, the input parameter of the supported CSI measurement mode includes one or more of the following: the size of time-domain and/or frequency-domain resource blocks where CSI measurement is to be performed, the format of reference signals, the size of resource blocks where the reference signals are located, etc.

The CSI calculation timeline of the UE includes the duration required for the UE to obtain the CSI measurement result based on at least one reference signal and prepare to transmit the CSI measurement result through an uplink channel. The CSI calculation timeline may be the minimum duration required for the UE to perform CSI calculation. In other words, the UE needs to execute the following operations during the CSI calculation: measuring the reference signal, and processing the measurement result to obtain a CSI measurement result on a time-domain resource block where CSI measurement is to be performed; and then, bearing and transmitting the CSI measurement result on a specified uplink channel (PUSCH or PUCCH) indicated by the base station. The bearing and transmitting the CSI measurement result on the specified uplink channel (PUSCH or PUCCH) indicated by the base station includes: performing encoding, modulation, and mapping on the CSI measurement result. The above operation process may be interpreted as a preparation process before the UE reports the CSI measurement result. After the preparation process is completed, the CSI measurement result can be reported through the specified uplink channel (uplink transmission). Thus, the duration required for this preparation process is the duration required for the UE to perform CSI calculation. The UE needs to prepare the reporting of the CSI measurement result within the CSI calculation timeline.

In an NR system, the CSI calculation timeline is stipulated in the protocol. Specifically, when the UE receives the PDCCH-triggered CSI report in a PUSCH, the UE should provide a valid CSI report. The first uplink symbol bearing the CSI report includes a timing advance that is not earlier than the symbol Z, where Z is the time delay for the UE to calculate CSI. According to different sub-carrier intervals and different report types, the capabilities for multiple different CSI calculation timelines are defined in the protocol. The UE needs to report the time delay for CSI calculation (the required minimum duration) to the base station. Since the channel prediction method provided in the embodiment of the present disclosure may be different from the CSI calculation timeline required by the conventional methods, one or more new CSI calculation timelines may be defined in the protocol. The UE needs to report the duration, so that the base station can allocate an uplink channel for CSI reporting according to the CSI calculation timeline of the UE. Specifically, since different measurement modes may require different calculation amount, complexity or the like, different durations required for CSI calculation may be defined or reported for different measurement modes. For example, the CSI calculation timeline according to the AI model 1 is x milliseconds, the CSI calculation timeline according to the AI model 1 is y milliseconds, and the CSI calculation timeline without prediction is z milliseconds. In another example, different CSI calculation timelines may be defined according to the size or position of the time-frequency resource where CSI measurement is to be performed.
(2) The UE receives the corresponding CSI measurement configuration information issued by the base station. As described above, the base station may configure one or more measurement modes for the UE. For example, multiple measurement modes are configured, where the mode 1 is a non-prediction mode, the mode 2 is a prediction mode based on an AI model, and the mode 3 is a prediction mode not based on an AI model. In addition, the corresponding usage conditions may be configured for each measurement mode.
(3) The UE performs CSI measurement based on the received CSI measurement configuration to obtain a corresponding CSI measurement result.
(4) The UE reports the CSI.

The base station will configure an uplink channel for the UE to report the CSI. The configuration of the uplink channel needs to satisfy the CSI calculation timeline and the duration from the scheduling to transmission of the uplink channel. The CSI calculation timeline may be obtained by the base station according to the capability reported by the UE. The CSI calculation timeline may be defined according to different measurement modes, different reference signal configurations, different CSI measurement resource configurations, or different report contents. Specifically, if the UE needs to perform CSI measurement according to multiple reference signals, a longer duration may be required compared with the duration based on one reference signal. Or, at this time, the CSI calculation time interval needs to be calculated by using the last one of the multiple reference signals as a reference point. For another example, for different CSI measurement resources, for example, the CSI calculation timeline required in a case where the resources whose CSI is to be measured are frequency-domain resources except for the resources where reference signals are located may be different the CSI calculation timeline required in a case where the resources whose CSI is to be measured are frequency-domain resources among the resources where the reference signals are located. For another example, different CSI calculation timelines are defined according to different report contents, etc.

In one optional embodiment of the present disclosure, the supported measurement mode reported to the base station includes at least one of the following. The measurement mode includes a non-prediction mode or a prediction mode. Or, the measurement mode may include a measurement mode not based on an AI model or a measurement mode based on an AI model.

In addition, the input and/or input parameter applied to the AI measurement may be in a fixed format. Since some AI models will be trained offline (pre-trained and preset in the device), different input and output parameters or formats will correspond to different AI models. For example, the input and/or output of one AI model may only support a fixed number of PRBs and/or a fixed number of symbols. For example, the AI model 1 only supports 6 PRBs and 7 symbols as the input of the AI to obtain the channel status information of the resource where CSI measurement is to be performed. If the size of the resource where CSI measurement is to be performed is 12 PRBs and 14 symbols, the AI model 1 may be called for 4 times, and the output results are spliced. To avoid excessive training of the AI model, some parameters may be predefined in the protocol. For example, the output unit of the AI model may be several groups of such basic time-domain resource blocks {X PRBs, Y symbols}. For example, it is predefined that the size of the resource block output by capability 1 is {6PRBs, 7 symbols} and the size of the resource block output by capability 2 is {12PRBs, 14 symbols}. The UE may report its supported capabilities to the base station. The base station allocates, for the UE and according to the capabilities reported by the UE, the size of the resource block where CSI is to be performed that matches with the capabilities. For example, the size of the resource block where CSI is to be performed may be formed by the capabilities supported by the UE or the linear combination of the capabilities supported by the UE. Upon receiving the CSI measurement result reported by the UE, the base station may perform further processing to obtain the channel status information required by scheduling the base station. Specifically, a UE reports to the base station that the size of the resource block output by the supported capability 1 is {6 PRBs, 7 symbols}. Thus, the base station configures for the UE that the size of the resource block where CSI measurement is to be performed may be {6 PRBs, 7symbols}, {12 PRBs, 7 symbols}, {6 PRBs, 14 symbols}, etc.

Similarly, some similar capabilities may also be defined for the format related to the input reference signal. For example, these similar capabilities include the size of the input resource block, the format of the reference signal (e.g., different time-domain intervals, different frequency-domain densities, the positions of different pilots, the number of time-domain pilots, etc.), etc. Similarly, the format of the output channel information or the size relationship between resources where CSI measurement is to be performed and reference signals (e.g., whether it is a time-domain prediction (measuring the time domain after the time-domain positions where the reference signals are located) or a frequency-domain perdition (measuring the frequency-domain resources except for the frequency-domain resources where the reference signals are located) may be reported to the base station as the UE's capabilities. The base station performs relevant configurations according to the capabilities reported by the UE.

In one optional embodiment of the present disclosure, the report content includes at least one of the following:
at least one CSI measurement result;

frequency-domain bandwidth information corresponding to at least one CSI measurement result;
information about time-domain and/or frequency-domain positions of at least one CSI measurement result;

Doppler information corresponding to at least one CSI measurement result; and
a measurement mode corresponding to at least one CSI measurement result.

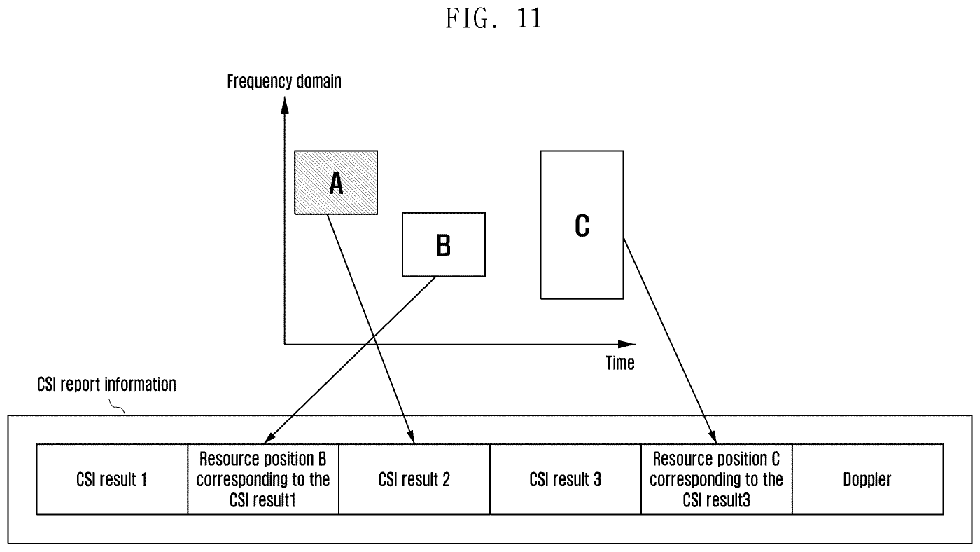

As shown in FIG. 11, in one example, the CSI report information includes multiple CSI results, and the time-domain and/or frequency-domain resource positions corresponding to some CSI results. As shown in FIG. 11, the CSI report information includes a CSI result 1 and a resource position B corresponding to the CSI result 1, a CSI result 2, a CSI result 3 and a resource position C corresponding to the CSI result 3, and Doppler information. Since the CSI result 1 has no corresponding resource position, according to the preconfigured or defined criterion, the corresponding CSI measurement result is the resource position A where the pilot is located. In addition, the CSI report information may further include a reporting mode adopted by the CSI result. For example, the CSI result 1 is predicted by the AI model 1, the CSI result 1 is not predicted, and the CSI result 3 is predicted by the non-AI model. This method can provide rich information of the base station to determine whether some reported results are accurate, so that the system performance is improved.

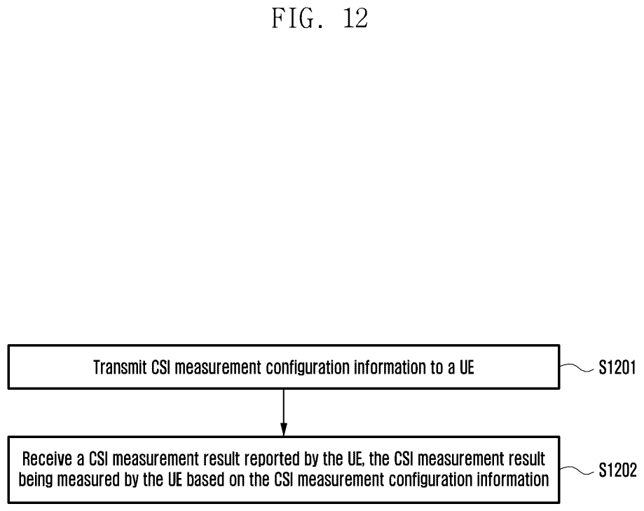

FIG. 12 is a flowchart of a method executed by a base station in a communication system according to an embodiment of the present application. As shown in FIG. 12, the method may include the following actions.

At S1201, CSI measurement configuration information is transmitted to a UE.

At S1202, a CSI measurement result reported by the UE is received, wherein the CSI measurement result is measured by the UE based on the CSI measurement configuration information.

Similarly, the method provided in the embodiment of the present application corresponds to the method in the embodiments on the UE side, and the detailed functional descriptions and the achieved beneficial effects can specifically refer to the above descriptions of the corresponding method in the embodiments on the UE side and will not be repeated here.

An embodiment of the present disclosure provides a user equipment. The user equipment may specifically include a configuration information acquisition module and a measurement report module, wherein the configuration information acquisition module is configured to acquire CSI measurement configuration information, and the measurement report module is configured to perform CSI measurement and reporting based on the CSI measurement configuration information.

In one optional embodiment of the present disclosure, the CSI measurement configuration information includes at least one of the following:
reference signal configuration information, usage conditions corresponding to one or more measurement modes, CSI measurement resource configuration information, measurement mode indication information, and report content.

In one optional embodiment of the present disclosure, the measurement mode includes a non-prediction mode or a prediction mode.

In one optional embodiment of the present disclosure, the measurement mode includes a non-AI mode or an AI mode.

In one optional embodiment of the present disclosure, the usage conditions corresponding to the measurement mode include at least one of the following:
a size relationship between a Doppler value and a threshold for Doppler;
a size relationship between a moving speed value and a threshold for moving speed;
a size relationship between a specified measurement result at a reference signaling position and a threshold for the specified measurement result; and the accuracy corresponding to a different measurement mode.

In one optional embodiment of the present disclosure, the reference signal configuration information includes at least one of the following: one or more reference signals;
time-domain position information of one or more reference signals; and

frequency-domain position information of one or more reference signals.

In one optional embodiment of the present disclosure, the reference signal satisfies at least one of the following conditions:
having the same Tx beam;
adopting the same precoding;
adopting the same transmission power;
adopting the same QCL; and
being indicated by the same TCI.

In one optional embodiment of the present disclosure, the measurement resource configuration information includes information about time-domain and/or frequency-domain positions where CSI measurement is to be performed.

In one optional embodiment of the present disclosure, the resources indicated by the information about time-domain and/or frequency-domain positions where CSI measurement is to be performed include the positions of all or some of reference signals in the reference signal configuration information, or other reference signals not in the reference signal configuration information.

In one optional embodiment of the present disclosure, the information about time-domain and/or frequency-domain positions where CSI measurement is to be performed includes at least one of the following:
one or more time-domain positions;
one or more frequency-domain positions;
one or more time intervals from the specified reference signaling position;
a frequency-domain offset from the specified reference signaling position;
the number of time-domain resources where CSI measurement is to be performed; and
the number of frequency-domain resources where CSI measurement is to be performed.

In one optional embodiment of the present disclosure, the configuration information acquisition module is specifically configured to:

perform CSI measurement based on the one or more measurement modes and the usage conditions corresponding to the one or more measurement modes; and/or perform CSI measurement based on the measurement mode indication information.

In one optional embodiment of the present disclosure, the report content includes at least one of the following:
at least one CSI measurement result;
frequency-domain bandwidth information corresponding to at least one CSI measurement result;
information about time-domain and/or frequency-domain positions of at least one CSI measurement result;

Doppler information corresponding to at least one CSI measurement result; and
a measurement mode corresponding to at least one CSI measurement result.

In one optional embodiment of the present application, the method further includes:
reporting the UE capability to a base station, the UE capability comprising at least one of the following: the supported CSI measurement mode, the supported CSI content, input parameter(s) of the supported CSI measurement mode, and CSI calculation timeline.

An embodiment of the present disclosure provides a base station. The base station may specifically include a configuration information transmitting module and a measurement result receiving module, wherein the configuration information transmitting module is configured to transmit CSI measurement configuration information to a UE; and, the measurement result receiving module is configured to receive a CSI measurement result reported by the UE, wherein the CSI measurement result is measured by the UE based on the CSI measurement configuration information.

The user equipment and the base station provided in the embodiments of the present disclosure can execute the methods provided in the embodiments of the present application, and the implementation principles thereof are similar. The acts executed by the modules in the user equipment and the base station provided in the embodiment of the present application correspond to the actions in the methods provided in the embodiments of the present application. The detailed functional descriptions of the modules in the user equipment and the base station and the achieved beneficial effects can refer to the descriptions of the corresponding methods described above and will not be repeated here.

An embodiment of the present disclosure provides an electronic device, including: a transceiver configured to transmit and receive signals; and, a processor, which is coupled to the transceiver and configured to control to implement the actions in the above method embodiments. Optionally, the electronic device may be a UE, and the processor in the electronic device is configured to control to implement the actions of the method executed by a UE provided in the method embodiments. Optionally, the electronic device may be a base station, and the processor in the electronic device is configured to control to implement the actions of the method executed by a base station provided in the method embodiments.

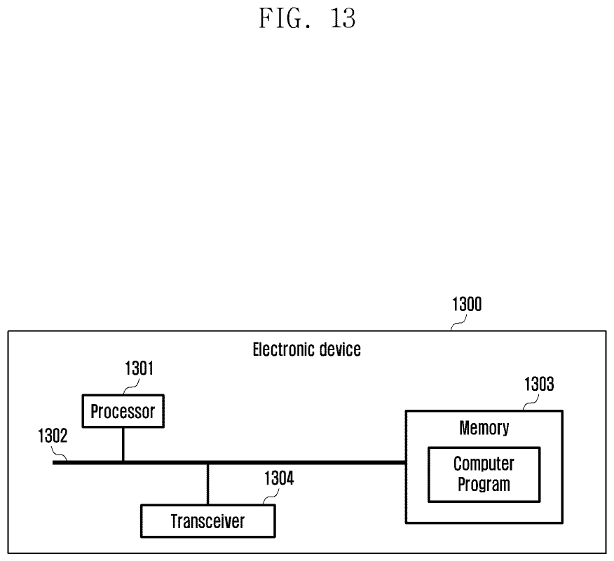

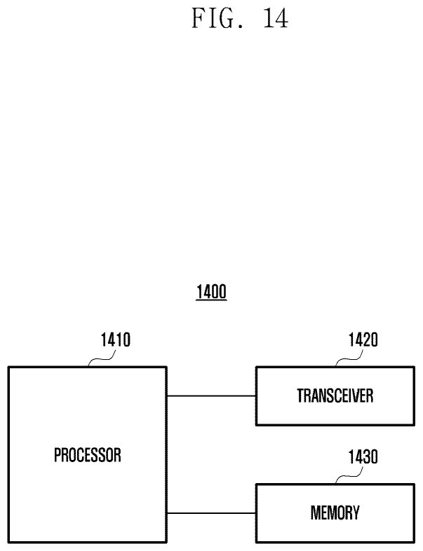

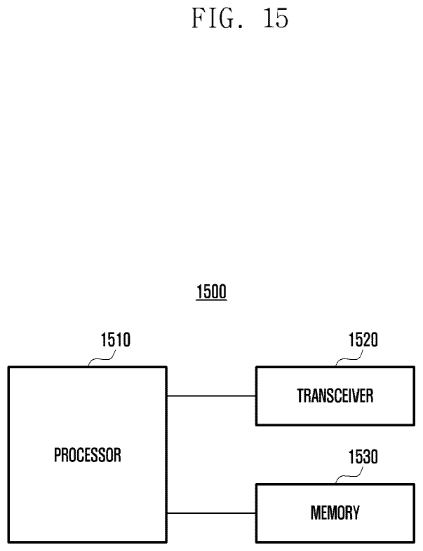

In an optional embodiment, an electronic device is provided, as shown in FIG. 13. The electronic device 1300 shown in FIG. 13 includes a processor 1301 and a memory 1303. The processor 1301 is connected to the memory 1303, for example, via a bus 1302. Optionally, the electronic device 1300 may also include a transceiver 1304, which may be used for data interaction between this electronic device and other electronic devices, such as data transmission and/or data reception. It should be noted that the transceiver 1304 is not limited to one in practical applications, and the structure of the electronic device 1300 does not constitute a limitation of this application embodiment.

The processor 1301 may be a central processing unit (CPU), a general-purpose processor, a digital signal processor (DSP), an application specific integrated circuit (ASIC), and a field programmable gate array (FPGA), or other programmable logic devices, transistor logic device, hardware component, or any combination thereof. It is possible to implement or execute the various exemplary logical blocks, modules, and circuits described in combination with the disclosures of the present disclosure. The processor 1301 may also be a combination of computing functions, such as a combination of one or more microprocessors, a combination of a DSP and a micro-processor, and so on.

The bus 1302 can include a path for delivering information among the above components. The bus 1302 may be a peripheral component interconnect (PCI) bus or an extended industry standard architecture (EISA) bus. The bus 1302 may be divided into an address bus, a data bus, a control bus, and so on. For ease of illustration, only one bold line is shown in FIG. 13, but does not indicate that there is only one bus or type of bus.

The memory 1303 may be a read-only memory (ROM) or other types of static storage devices that can store static information and instructions, a random access memory (RAM) or other types of storage devices that can store information and instructions. The memory 1303 may also be electrically erasable programmable read-only memory (EEPROM), compact disc read-only memory (CD-ROM), or other optical disk storage, optical disk storage (including compressed compact disc, laser disc, compact disc, digital versatile disc, blue-ray disc, etc.), magnetic disk storage medium or other magnetic storage devices, or any other medium capable of carrying or storing computer programs and capable of being accessed by a computer, but not limited to this.

The memory 1303 is used to store computer programs for executing embodiments of the present disclosure and is controlled for execution by the processor 1301. The processor 1301 is used to execute the computer program stored in memory 1303 to implement the steps shown in the preceding method embodiment.

Embodiments of the present disclosure provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

FIG. 14 illustrates a block diagram of a base station (BS) according to embodiments of the present disclosure.

Referring to the FIG. 14, the BS 1400 may include a processor 1410, a transceiver 1420 and a memory 1430. However, all of the illustrated components are not essential. The BS 1400 may be implemented by more or less components than those illustrated in FIG. 14. In addition, the processor 1410 and the transceiver 1420 and the memory 630 may be implemented as a single chip according to another embodiment.

The aforementioned components will now be described in detail.

The processor 1410 may include one or more processors or other processing devices that control the proposed function, process, and/or method. Operation of the BS 1400 may be implemented by the processor 1410.

The transceiver 1420 may include a RF transmitter for up-converting and amplifying a transmitted signal, and a RF receiver for down-converting a frequency of a received signal. However, according to another embodiment, the transceiver 1420 may be implemented by more or less components than those illustrated in components.

The transceiver 1420 may be connected to the processor 1410 and transmit and/or receive a signal. The signal may include control information and data. In addition, the transceiver 1420 may receive the signal through a wireless channel and output the signal to the processor 1410. The transceiver 1420 may transmit a signal output from the processor 610 through the wireless channel.

The memory 1430 may store the control information or the data included in a signal obtained by the BS 1400. The memory 1430 may be connected to the processor 1410 and store at least one instruction or a protocol or a parameter for the proposed function, process, and/or method. The memory 1430 may include read-only memory (ROM) and/or random access memory (RAM) and/or hard disk and/or CD-ROM and/or DVD and/or other storage devices.

FIG. 15 illustrates a user equipment (UE) according to embodiments of the present disclosure.

Referring to the FIG. 15, the UE 1500 may include a processor 1510, a transceiver 1520 and a memory 1530. However, all of the illustrated components are not essential. The UE 1500 may be implemented by more or less components than those illustrated in FIG. 15. In addition, the processor 1510 and the transceiver 1520 and the memory 1530 may be implemented as a single chip according to another embodiment.

The aforementioned components will now be described in detail.

The processor 1510 may include one or more processors or other processing devices that control the proposed function, process, and/or method. Operation of the UE 1500 may be implemented by the processor 1510.

The transceiver 1520 may include a RF transmitter for up-converting and amplifying a transmitted signal, and a RF receiver for down-converting a frequency of a received signal. However, according to another embodiment, the transceiver 1520 may be implemented by more or less components than those illustrated in components.

The transceiver 1520 may be connected to the processor 1510 and transmit and/or receive a signal. The signal may include control information and data. In addition, the transceiver 1520 may receive the signal through a wireless channel and output the signal to the processor 1510. The transceiver 1520 may transmit a signal output from the processor 1510 through the wireless channel.

The memory 1530 may store the control information or the data included in a signal obtained by the UE 1500. The memory 1530 may be connected to the processor 1510 and store at least one instruction or a protocol or a parameter for the proposed function, process, and/or method. The memory 1530 may include read-only memory (ROM) and/or random access memory (RAM) and/or hard disk and/or CD-ROM and/or DVD and/or other storage devices.

Certain examples of the present disclosure may be provided in the form of a base station (e.g. gNB) and/or method therefore. Certain examples of the present disclosure may be provided in the form of a mobile device (e.g. UE) and/or method therefore. Certain examples of the present disclosure may be provided in the form of a system comprising one or more base stations and one or more mobile devices, and/or method therefore.

The embodiments described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation of X may be performed by a module configured to perform X (or an X-module). The one or more elements may be implemented in the form of hardware, software, or any combination of hardware and software.

The skilled person will appreciate that a given process, operation and/or method step disclosed herein may be performed by a single entity (hardware and/or software), or the performance of such a process, operation and/or method step may be distributed and performed by two or more entities in cooperation. The skilled person will also ap-preciate that a single entity (hardware and/or software) may be configured to perform one process, operation and/or method step disclosed herein, or may be configured to perform two or more such processes, operations and/or method steps.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain example provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

The above flowcharts and flow diagrams illustrate examples of methods and processes that can be implemented in accordance with the principles of the present disclosure and various changes could be made to the methods and processes illustrated in the flowcharts and flow diagrams. For example, while shown as a series of steps, various steps in each figure could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined only by the claims.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the present disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The above-mentioned description is merely an alternative embodiment for some implementation scenarios of the present disclosure, and it should be noted that it would have been within the scope of protection of embodiments of the present disclosure for those skilled in the art to adopt other similar implementation means based on the technical idea of the present disclosure without departing from the technical concept of the solution of the present disclosure.

1. A method executed by a user equipment (UE) in a communication system, comprising:
acquiring CSI measurement configuration information; and
wherein the CSI measurement configuration information comprises at least one of the following:
reference signal configuration information, a usage condition corresponding to one or more measurement modes, CSI measurement resource configuration information, measurement mode indication information, and report content.

2. The method according to claim 1, wherein the measurement mode comprises a non-prediction mode or a prediction mode.

3. The method according to claim 1, wherein the measurement mode comprises a non-AI mode or an AI mode.

4. The method according to claim 1, wherein the usage condition corresponding to the measurement mode comprises at least one of the following:
a size relationship between a Doppler value and a threshold for Doppler;
a size relationship between a moving speed value and a threshold for moving speed;
a size relationship between a specified measurement result at a reference signaling position and a threshold for the specified measurement result; and
accuracies corresponding to different measurement modes.

5. The method according to claim 1, wherein the reference signal configuration information comprises at least one of the following: one or more reference signals;
time-domain position information of one or more reference signals; and
frequency-domain position information of one or more reference signals.

6. The method according to claim 5, wherein the reference signal satisfies at least one of the following conditions:
with the same Tx beam;
adopting the same precoding;
adopting the same transmission power;
adopting the same QCL; and
being indicated by the same TCI.

7. The method according to claim 1, wherein the measurement resource configuration information comprises information about a time-domain and/or a frequency-domain position where CSI measurement is to be performed.

8. The method according to claim 7, wherein the resources indicated by the information about a time-domain and/or a frequency-domain position where CSI measurement is to be performed comprise the positions of all or some of the reference signals in the reference signal configuration information, or other reference signals not in the reference signal configuration information.

9. The method according to claim 7, wherein the information about a time-domain and/or a frequency-domain position where CSI measurement is to be performed comprises at least one of the following:
one or more time-domain positions;
one or more frequency-domain positions;
one or more time intervals from the specified reference signaling position;
a frequency-domain offset from the specified reference signaling position;
the number of time-domain resources where CSI measurement is to be performed; and
the number of frequency-domain resources where CSI measurement is to be performed.

10. The method according to claim 1, wherein the performing CSI measurement based on the CSI measurement configuration information comprises:
performing CSI measurement based on the one or more measurement modes and the usage conditions corresponding to the one or more measurement modes; and/or
performing CSI measurement based on the measurement mode indication information.

11. The method according to claim 1, wherein the report content comprises at least one of the following:
at least one CSI measurement result;
frequency-domain bandwidth information corresponding to at least one CSI measurement result;
information about a time-domain and/or frequency-domain position of at least one CSI measurement result;
Doppler information corresponding to at least one CSI measurement result; and
a measurement mode corresponding to at least one CSI measurement result.

12. The method according to claim 1, further comprising:
reporting the UE capability to a base station, the UE capability comprising at least one of the following: supported CSI measurement mode(s), supported CSI content, input parameter(s) of the supported CSI measurement mode, and CSI calculation timeline.

13. A method executed by a base station in a communication system, comprising:
transmitting CSI measurement configuration information to a UE; and
receiving a CSI measurement result reported by the UE, wherein the CSI measurement result is measured by the UE based on the CSI measurement configuration information, wherein the CSI measurement configuration information comprises at least one of the following:
reference signal configuration information, a usage condition corresponding to one or more measurement modes, CSI measurement
resource configuration information, measurement mode indication information, and report content.

14. A user equipment, comprising:
a transceiver; and
at least one processor configured to:
acquire CSI measurement configuration information; and
perform CSI measurement and reporting based on the CSI measurement configuration information,
wherein the CSI measurement configuration information comprises at least one of the following:
reference signal configuration information, a usage condition corresponding to one or more measurement modes, CSI measurement resource configuration information, measurement mode indication information, and report content.

15. A base station, comprising:
a transceiver; and
at least one processor configured to:
transmit CSI measurement configuration information to a UE; and
receive a CSI measurement result reported by the UE, wherein the CSI measurement result is measured by the UE based on the CSI measurement configuration information,
wherein the CSI measurement configuration information comprises at least one of the following:
reference signal configuration information, a usage condition corresponding to one or more measurement modes, CSI measurement resource configuration information, measurement mode indication information, and report content.
